(19) United States
(12) Patent Application Publication
(10) Pub. No.: US 2013/0242526 A1
(43) Pub. Date: Sep. 19, 2013

(54) STUDIO LIGHT-DEFLECTION AND CONTROL CONE

(71) Applicant: Felix Roger Williams, Los Angeles, CA (US)

(72) Inventor: Felix Roger Williams, Los Angeles, CA (US)

(21) Appl. No.: 13/423,269

(22) Filed: Mar. 18, 2012

(51) Int. Cl. G03B 15/06

(52) U.S. Cl. 362/17

(57) ABSTRACT

A studio light and deflection cone softens the harsh light that is produced by studio lighting instruments, in order to show fewer wrinkles and imperfections on the actors' faces and to create more appealing and flattering facial features for the purpose of photography. The cone attaches to the front of a studio lighting instrument. As light is projected into the rear of the cone, it passes through a primary gel frame that is covered with light deflecting material that spreads the beam. Inside the cone, the light reflects off the ultra-white interior of the cone, is intensified, and passes through the secondary gel frame that is covered with light deflecting material. Upon leaving the cone, the light passes through the control grid at the very front of the cone that narrows the spread of the light exiting the cone in degrees to produce a very soft and controlled light.

### BACKGROUND OF THE INVENTION

The present invention relates to lighting control systems and, more particularly, to a studio light-deflection and control cone.

Conventional studio lighting can be very harsh. Such harsh lighting can show wrinkles and imperfections on actors' faces, resulting in unflattering facial features for the purpose of photography. Conventional light softening devices are usually time consuming to assemble, bulky and only include a single layer of light deflecting material that is time consuming to change. Moreover, most conventional light softening devices have no venting system and are difficult, if not impossible, to adjust to fit different size lamps. These light softening devices are usually not very durable and are difficult to store.

As can be seen, there is a need for an improved studio light deflection and control device.

### SUMMARY OF THE INVENTION

In one aspect of the present invention, a studio light adjustment device, comprises a cone; a primary flange adapted to removably attach a primary gel frame to the cone at a first end thereof; a secondary flange adapted to removably attach a secondary gel frame to a second, opposite end of the cone; and a control grid adapted to be removably attached to the cone.

In another aspect of the present invention, a cone lighting system comprises a cone having an ultra-white finish on an interior thereof; a primary flange adapted to removably attach a primary gel frame to the cone at a first end thereof; adjustable ears attached to the primary flange, the adjustable ears adapted to connect the primary flange to a lamp; a secondary flange adapted to removably attach a secondary gel frame to a second, opposite end of the cone; and a control grid adapted to be removably attached to the cone.

These and other features, aspects and advantages of the present invention will become better understood with reference to the following drawings, description and claims.

### BRIEF DESCRIPTION OF THE DRAWINGS

FIG. 1 is a perspective view of a studio light deflection and control cone according to an exemplary embodiment of the present invention;

FIG. 2 is a rear perspective view of the studio light deflection and control cone of FIG. 1;

FIG. 3 is a top, exploded perspective view of the studio light deflection and control cone of FIG. 1;

FIG. 4 is a front view of a gel frame used in the studio light deflection and control cone of FIG. 1;

FIG. 5 is a front view of a control grid used in the studio light deflection and control cone of FIG. 1; and

FIG. 6 is a detail view showing a secondary gel frame being inserted in the studio light deflection and control cone of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a studio light and deflection cone used in studio lighting applications. The function of the cone is to soften the harsh light that is produced by studio lighting instruments, in order to show less wrinkles and imperfections on the actors' faces and to create more appealing and flattering facial features for the purpose of photography. By deflecting the light rays or bending them you are softening the light. The more you bend the light rays the softer the light. The softer the light the more flattering and less noticeable the winkles and imperfections are. By having two layers of light deflecting material attached to interchangeable frames the lights ray are being bent to the maximum creating the ultimate soft light with the ability to control it. The cone attaches to the front of a studio lighting instrument. As light is projected into the rear of the cone, it passes through the primary gel frame that is covered with light deflecting material that spreads the beam. Inside the cone, the light reflects off the ultra-white interior of the cone and is intensified, then passes through the secondary gel frame that is covered with light deflecting material and is softened even further. Upon leaving the cone, it passes through the control grid at the very front of the cone that narrows the spread of the light exiting the cone in degrees to produce a very soft and controlled light.

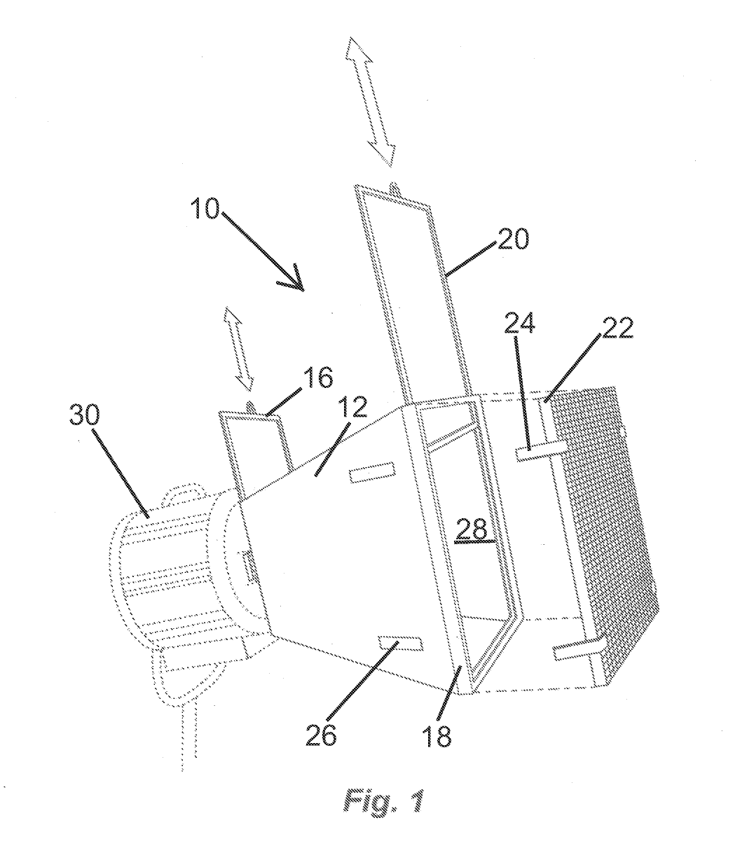

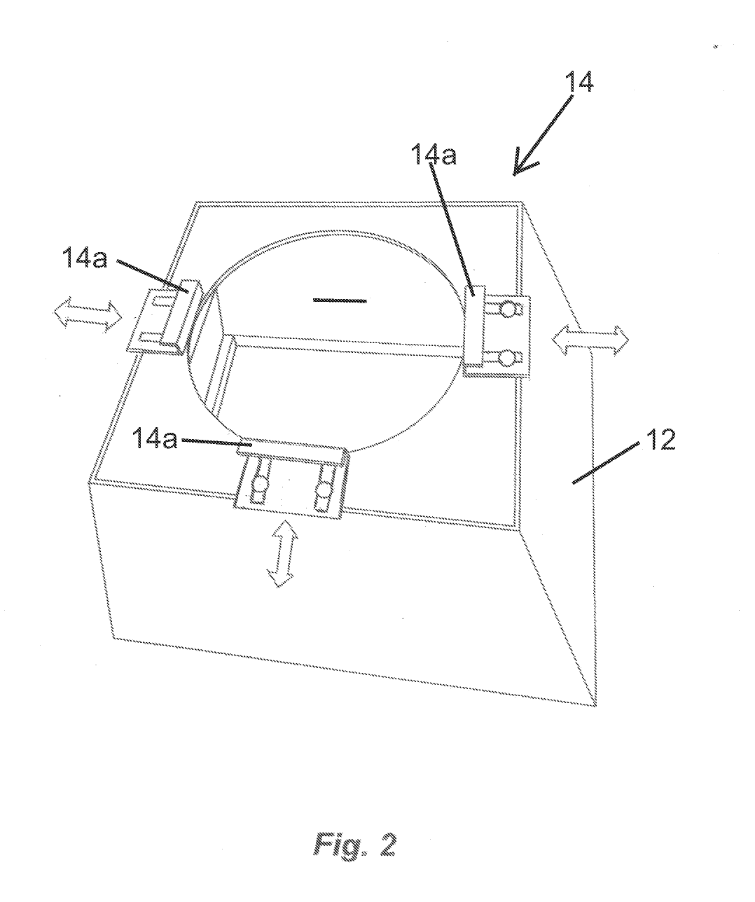

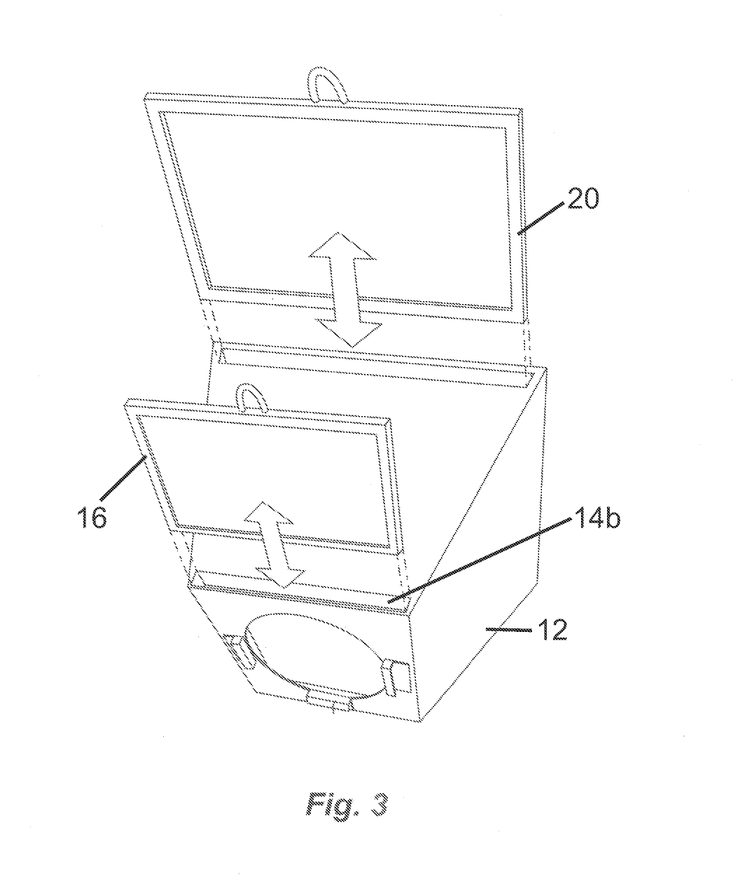

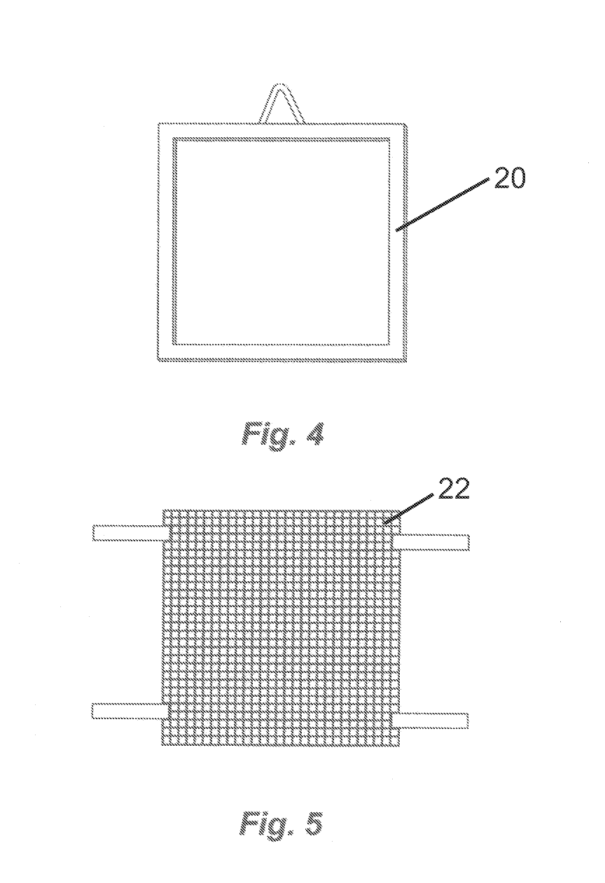

Referring now to FIGS. 1 through 6, a studio light deflection cone system 10 includes three sections. The first section includes a primary flange 14 located at the rear of a cone 12. The primary flange 14 may be made from sheet metal and can be used to attach the unit to a studio lamp 30 by means of adjustable ears 14a on the back of the flange 14. These ears 14a may interlock with ears (not shown) on the front of the studio lamp 30 to secure the cone 12 to the lamp 30. The primary flange 14 may also support the rear of the cone 12. Furthermore, the primary flange 14 may support a guide track 14b that a primary gel frame 16 can slide in and out thereof.

The second section of the cone system 10 includes the cone 12. The cone 12 may be made from, for example, corrugated plastic that may be treated with flame and heat retardant paint. The cone 12 can contain the light rays traveling through the cone 12 to a secondary flange 18. The cone 12 can also intensify the light as it reflects of an interior 28 of the cone 12. Typically, the interior 28 of the cone 12 may have a ultra-white surface.

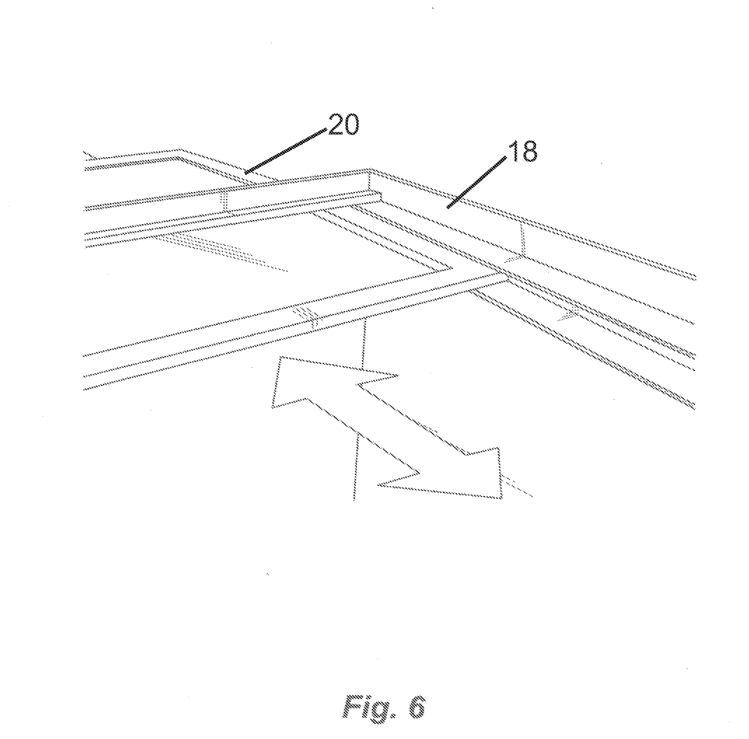

The third section of the cone system 10 is located at a front end of the cone system 10 and includes the secondary flange 18. The secondary flange 18 is typically made from aluminum and can support the front of the cone 12. The secondary flange 18 may also serve as a guide (see FIG. 6) for a secondary gel frame 20 to slide in and out thereof. The secondary flange 18 may also hold a control grid 22.

The control grid 22 may be used to narrow the spread of the light exiting from the cone system 10 to produce a very soft and controlled light. The control grid 22 may be optional, and may be varied to configure the desired spread of light. The control grid 22 may include a plurality of arms 24 that extend from the control grid 22 to engage with recesses 26 on the cone 12. Other connections may be used to connect the control grid 22 to the cone 12. For example, the arms 24 may include a hook and loop fastener, such as Velcro® to attach to a hook and loop fastener disposed on the cone 12.

As light is projected into the rear of the cone 12, it passes through the primary gel frame 16 that is covered with light deflecting material that spreads the beam. Inside the cone 12, the light reflects off the ultra-white interior 28 of the cone 12 and is intensified. The light then passes through the secondary gel frame 20 that is covered with light deflecting material and is softened even further. Upon leaving the cone 12, the light passes through the control grid 22 at the very front of the cone 12. The control grid 22 narrows the spread of the light exiting the cone 12 in degrees to produce a very soft and controlled light.

The cone system 10 may be used with or without both gel frames. For example, the secondary gel frame 20 may be removed if desired. Also, the control grid 22 may be removed if desired. The material of the gel frames 16, 20 may be varied, depending on the desired level of light softening. The shape and size of the cone system 10 may vary to accommodate various studio lights.

It should be understood, of course, that the foregoing relates to exemplary embodiments of the invention and that modifications may be made without departing from the spirit and scope of the invention as set forth in the following claims.

What is claimed is:

1. A studio light adjustment device, comprising:
a cone;
a primary flange adapted to removably attach a primary gel frame to the cone at a first end thereof;
a secondary flange adapted to removably attach a secondary gel frame to a second, opposite end of the cone; and
a control grid adapted to be removably attached to a light exit from the cone.

2. The studio light adjustment device of claim 1, wherein an interior of the cone has a ultra-white finish.

3. The studio light adjustment device of claim 1, further comprising adjustable ears attached to the primary flange, the adjustable ears adapted to connect the primary flange to a lamp.

4. The studio light adjustment device of claim 1, further comprising arms extending from the control grid, the arms adapted to secure the control grid to the cone.

5. The studio light adjustment device of claim 1, wherein the arms include a hook and loop connector adapted to connect to a hook and loop connector on the cone.

6. A cone lighting system comprising:
a cone having a ultra-white finish on an interior thereof;
a primary flange adapted to removably attach a primary gel frame to the cone at a first end thereof;
adjustable ears attached to the primary flange, the adjustable ears adapted to connect the primary flange to a lamp;
a secondary flange adapted to removably attach a secondary gel frame to a second, opposite end of the cone; and
a control grid adapted to be removably attached to the cone.

7. The studio light adjustment device of claim 6, further comprising arms extending from the control grid, the arms adapted to secure the control grid to the cone.

8. The studio light adjustment device of claim 6, wherein the arms include a hook and loop connector adapted to connect to a hook and loop connector on the cone.
